(19) United States
(12) Patent Application Publication
(10) Pub. No.: US 2016/0246622 A1
(43) Pub. Date: Aug. 25, 2016

(54) Method and system for implementing invocation stubs for the application programming interfaces embedding with function overload resolution for dynamic computer programming languages

(71) Applicant: Karlen Simonyan, Moscow (RU)

(72) Inventor: Karlen Simonyan, Moscow (RU)

(21) Appl. No.: 15/049,087

(22) Filed: Feb. 21, 2016

Related U.S. Application Data
(60) Provisional application No. 62/119,433, filed on Feb. 23, 2015.

(51) Int. Cl. G06F 9/455; G06F 9/45

(52) U.S. Cl. CPC G06F 9/4552; G06F 8/41

(57) ABSTRACT

Systems and methods for increasing the execution speed of external API functions invocation and runtime checks. The techniques for generating invocation stubs for an application programming interfaces embedding with functions overload resolution so that a script or program written in a dynamic high-level programming language may reuse existing code base from other high-level programming language and be more flexible than traditional approaches. The method further involves compiling the high-level code templates to native code to obtain optimized native code templates, using an optimizing compiler subsystem designed for runtime use with the virtual machine. With some of the described techniques, invocation stubs are generated by a compiler, when a corresponding API import instruction is encountered at runtime, and those stubs bridge an application programming interfaces to the actual programming language for usage.

### CROSS-REFERENCE TO RELATED APPLICATIONS

This application claims the benefit of U.S. Provisional Application No. 62/119,433, filed Feb. 23, 2015.

### BACKGROUND

Many different computer programming languages exist. Examples of programming languages include C# language by Microsoft Corporation and Java by Sun Microsystems, Inc. (which has since merged into Oracle Corporation). Computer programming languages are typically differentiated by their type system, where type is a programming construct that specifies a set of values and a set of operations that can be applied to these values, and an implementation method for storing, performing operations with these values, by which a computer program is composed of. Type systems are differentiated by type checking, i.e. dynamically or statically typed, and by type safety, i.e. strongly or weakly typed. Code written for a particular programming language is generally not directly compatible with other programming language.

Because different computer programming languages exist, software developers were historically required to rewrite completely or partially software for each programming language. However, with time, technologies have evolved that help reduce the amount of effort required to port written functions or modules from one programming language to another programming language. For example, the C programming language has relatively standard mechanism for exporting C Functions across different programming languages with application programming interface importing support.

In recent years, dynamically typed (dynamic) programming languages increased in popularity. Dynamic programming languages are computer programming languages designed to be executed step by step using interpreter or compiled using just-in-time compiler with execution within virtual machine. Examples of dynamically typed programming languages include Python™Ruby, JavaScript™ (dialect of the ECMAScript scripting language standardized by Ecma International in the ECMA-262 specification and ISO/IEC 16262).

Although dynamically typed programming languages increase portability and simplicity (in several scenarios) of software, there is computing overhead associated with using the external application programming interface (API). Specifically, as instructions in the computer program composed with the dynamically typed programming languages are encountered at runtime, the instructions must be converted to native instructions by the virtual machine or interpreter. The conversion of instructions gets more complicated in a case of dynamically weakly typed programming languages (example of this language is JavaScript™), because of variables and functions arguments type mutability even after interpretation or just-in-time compilation. In contrast, statically strongly typed languages compilation does not incur this overhead.

To resolve correct external application programming interface construct, i.e. function, struct and variants of, virtual machines and interpreters, have to get required information. Typically, such kind of information are represented by bindings, i.e. very similar declarations of application programming interfaces from one programming language in another. Programmer performs an initial translation of the program into native form for target language. In a case of very large code base the binding creation takes too long time.

Presently, no widely adopted, effective, and general-purpose solution exists that enables a programmer to perform binding creation quickly. Furthermore, no effective present solution exists that allows a programmer to be able to focus on the high-level logic of the application being programmed rather than focus on the specific implementation details of the target application programming interface.

Unfortunately, restrictions of program code, developed using dynamically typed programming language, such as type safety are often conflicts with speed and performance considerations. This can be particularly problematic for video game applications, where performance is the key consideration.

### BRIEF SUMMARY OF THE INVENTION

Various aspects of the present invention provide systems and methods for generating invocation stubs for an application programming interfaces by special kind of compiler or within existing virtual machine infrastructure. One aspect of the invention is directed to a technique for relevant function overload resolution within a programming language whose programming model and type system does not allow function overloading neither by arguments type nor by function's arguments list length and can be applied to extremely weakly typed dynamic programming languages such as the JavaScript™. Another aspect provides automatic external API importing service from one programming language to another with or without such kind of functionality embedding support. Additional aspects of the invention will become apparent in view of the following description and associated figures.

This Summary is provided to introduce a selection of concepts in a simplified form that are further described below in the Detailed Description. This Summary is not intended to identify key features or essential features of the claimed subject matter. The term “techniques”, for instance, may refer to system(s), method(s), and/or computer-readable instructions as permitted by the context above and throughout the document.

### BRIEF DESCRIPTION OF THE DRAWINGS

FIG. 1 shows how a JavaScript™ source code program is executed.

FIG. 2 shows relation between APIs exported function overload resolution and finite state machine (FSM) that describes each overload's aspects as a variety of states and inputs as one of an embodiment of the invention.

FIG. 3 shows relation between APIs exported function overload resolution and sample compiler-generated C# pseudo-code that describes a sample final invocation stub to be used within JavaScript™.

FIG. 4 is a process flow diagram of functional components suitable for use with the various aspects of an API exported functions importing into hosting environment of a dynamic programming language.

FIG. 5 is a process flow diagram that illustrates an aspect method for an API's exported function with or without overloads invocation stub generation to be used in dynamic language.

FIG. 6 illustrates a high level flowchart of an embodiment of the invention.

FIG. 7 shows the definition of an implementation of a compiler's runtime subsystem.

### DETAILED DESCRIPTION AND BEST MODE OF IMPLEMENTATION

In the following detailed description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

In general, embodiments of the invention provide a method and system for implementing a just-in-time compiler with specialization or only subsystem of it, including ahead-of-time compilation support.

To achieve a degree of software independence, the implementations are described as part of a general-purpose programming language that may be extended to support APIs export. The C# programming language is the primary example of such a language as is described herein. C# is a statically-typed, multi-paradigm, compiled, general-purpose programming language. C# may also be described as imperative, declarative, procedural, functional, object-oriented, and generic. The C# language is regarded as a mid-level programming language, as it comprises a combination of both high-level and low-level language features. The inventive concepts are not limited to expressions in the C# programming language. Rather, the C# language is useful for describing the inventive concepts. Examples of some alternative programming language that may be utilized include C, C++, Java™, Python™, Ruby, PHP, Delphi, F#, Haskell and JavaScript™. That said, some of the claimed subject matter may cover specific programming expressions in C# type language, nomenclature, and format.

The importing samples of the implementation are described as part of dynamic, weakly typed, object-oriented scripting language. The JavaScript™ is the primary example of such a language as is described herein. JavaScript™ implements the ECMAScript language standard (standardized by ECMA International in the ECMA-262 specification) and/or the ISO/IEC 16262 standard. JavaScript™ enables programmatic access to computational objects within a host environment, such as web browsers.

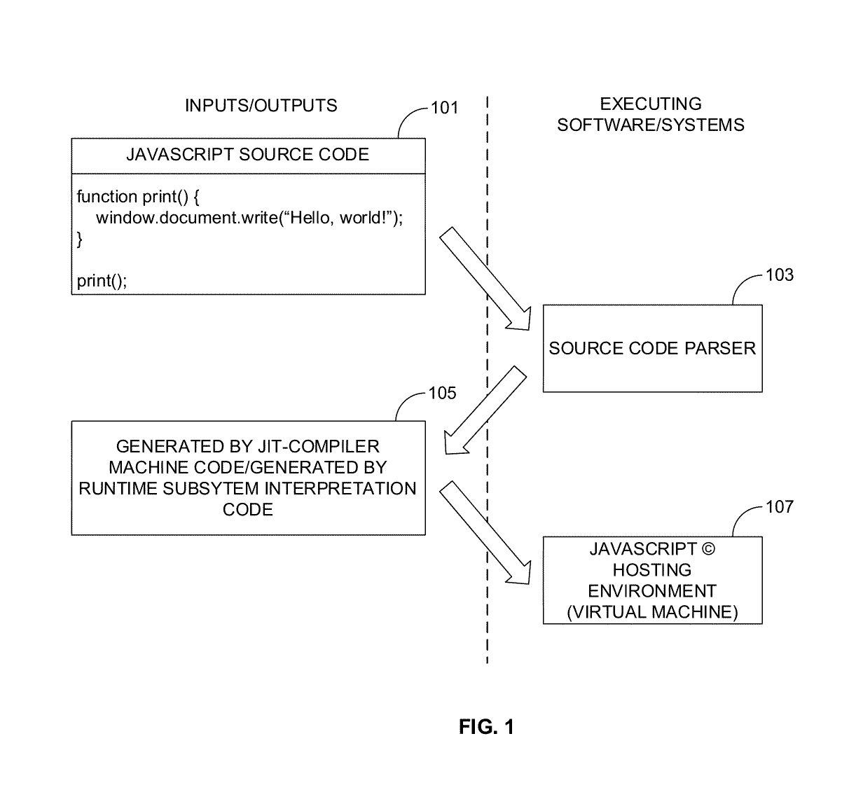

Typically, computer programs written in the JavaScript™ programming language are interpreted or compiled using JIT-compiler that are then executed by a JavaScript™ virtual machine, i.e. hosting environment as defined in the ECMA-262 specification and ISO/IEC 16262. FIG. 1 shows a progression of a simple piece of JavaScript™ source code through execution by an interpreter, the hosting environment.

The source code 101 includes the classic Hello World program written in JavaScript™, which is then input into a parser 103 that checks for syntax correctness and produces some output (usually abstract syntax tree). The JIT compiler outputs machine code instructions 105 for further execution of the JavaScript™ program.

Generated machine code instructions 105 are not necessary to be used. Moreover, the JIT compiler could be omitted in favor of an interpreter usage.

The output of the JIT-compiler or interpreter is input into a JavaScript™ virtual machine 107. The JavaScript™ virtual machine is a hosting environment that holds global variables and other programming constructs, while the code executes.

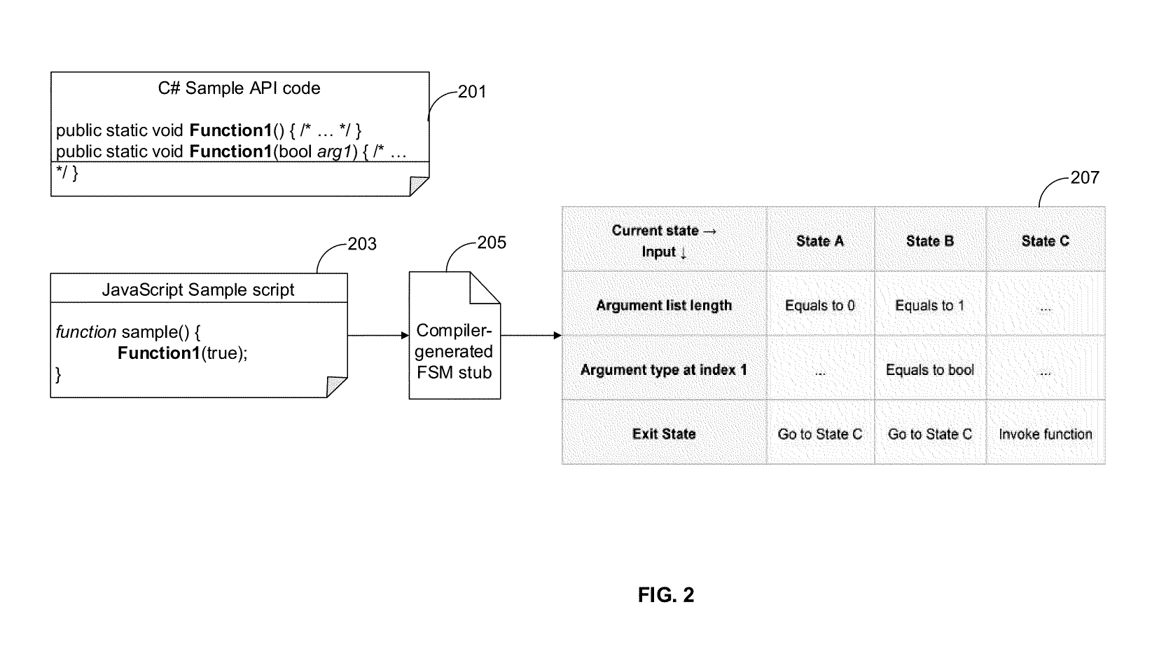

An application programming interface (i.e. any set of defined types, procedures, functions, structures and constants exposed an application, library or service for using in external software products) can be represented as a finite state machine (FSM as also referred) of N states, where each state corresponds to application programming interface element (type, function, etc.). A given state has a set of properties that describes given finite state machine actual state. FIG. 2 shows a typical relationship between the state of a FSM and exposed by an API a function with overloads. As shown in this particular figure, the method with signature Function1 (bool check) is most relevant overload because of correct number of arguments and first argument compatible converted type. We use a simplified case with convertible types and small number of arguments.

The simple case provided by FIG. 1 could be achieved using the well-known idea of complete enumeration, which has computational complexity O (log A) for function with overloads, where A is arithmetic mean

$$A = \frac{1}{n} {\sum }_{i = 1}^{n} {a}_{i}$$

The present method is more subtle and complex than complete enumeration and gives far superior results.

According to one embodiment of the present method of function overload selection, each function can be represented as a determistic finite state machine with exactly one transition for each possible input. The formula for this kind of FSM is typical ordered five

M=(V,Q,q₀,F,δ),

where V are functions arguments and their types, Q are a variety of states, q0 is default state (in a case of single function FSM has to only check number of arguments and arguments type) and (q₀) ∈Q, F are verity of enclosing states and F ⊂Q,δ is the state-transition function and δ:Q×(V∪{λ}→2^{Q} and δ(q,a)={r:q→ₐr}.

According to one embodiment of the present method of function overload resolution exposed by any computer programming language with type inheritance support via classes or via prototypes would be counted in determination of most relevant function overload, while complete enumeration, for example, finds only first relevant overload rather than target.

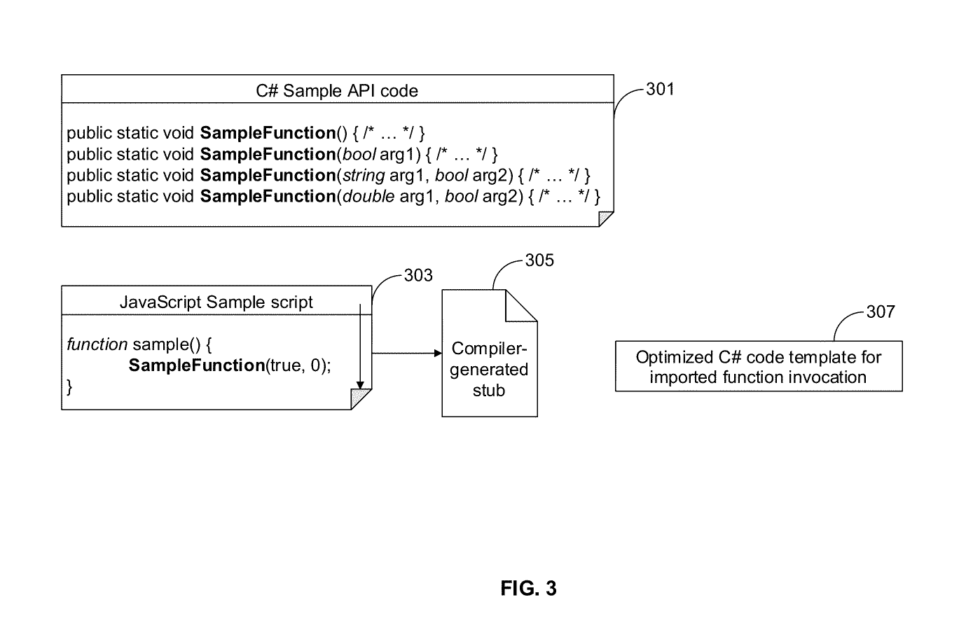

In order to illustrate the present method of function overload resolution, consider the simple case of functions shown in FIG. 3. Generated C# pseudocode for this API's functions using specialized FSM would be as follows in Table 1:

TABLE 1
Optimized C# code template for imported function invocation

public static void SampleFunctionCompilerStub(JavaScriptValue callableJsFunction,
JavaScriptValue[ ] arguments, out JavaScriptValue result)
{

switch (arguments.Length)
{

case 0:

SampleFunction( );
break;

case 1:

var firstArgumentType = Runtime.JSValueGetType(arguments[0]);
if (firstArgumentType == JavaScriptValueType.Boolean)
{

var booleanArgument1 = Runtime.JSValueGetBoolean(arguments[0]);
SampleFunction(booleanArgument1);

}
break;

case 2:

var secondArgumentType = Runtime.JSValueGetType(arguments[1]);
if (secondArgumentType != JavaScriptValueType.Boolean)

break;

var booleanArgument2 = Runtime.JSValueGetBoolean(arguments[1]);
firstArgumentType = Runtime.JSValueGetType(arguments[0]);
if (firstArgumentType == JavaScriptValueType.String)
{

var stringArgument = Runtime.JSValueGetString(arguments[0]);
SampleFunction(stringArgument, booleanArgument2);

}
else if (firstArgumentType == JavaScriptValueType.Number)
{

var numberArgument = Runtime.JSValueGetNumber(arguments[0]);
SampleFunction(numberArgument, booleanArgument2);

}
break;

}
result = Runtime.JSValueMakeUndefined( );

}

One algorithm for creating an invocation stub (as shown in Table 1 and FIG. 3) according to various embodiments is described below.
1. The algorithm begins by designating the entry of the compiler-generated invocation stub. In a case of a function overloads difference by arguments count existence, a jump table is created (i.e. using the C# switch construct, for example). Each code section is inserted into corresponding branch of the jump table. In a case of single function linking, i.e. the function without overloads, only one code section is generated.
2. The code section for current branch is generated:
   2.1. If current function overload has any argument in common with other ones, speculative type checking and conversion instructions are generated, implementing the semantic representation of current function's overloads, and inserted into current code section;
   2.2. Speculative type checking is performed for each of the remaining arguments of the function. In a case of unique argument existence the fall-through exit node is inserted into current code section;
   2.3. The last backtrack instruction is assigned as current section;
   2.4. If current code section is an unconditional jump instruction, its jump target is designated as current code section;
   2.5. If no corresponding arguments are found for invocation, the control flow moves to step 3 below;
   2.6. If current function overload has been translated, its last backtrack instruction is assigned as the next type checking code section and its backtrack entry node is designated as the current code section branch; Step 2 above in then repeated.
3. The epilog exit code is inserted into current branch, completing the creation of the code section.

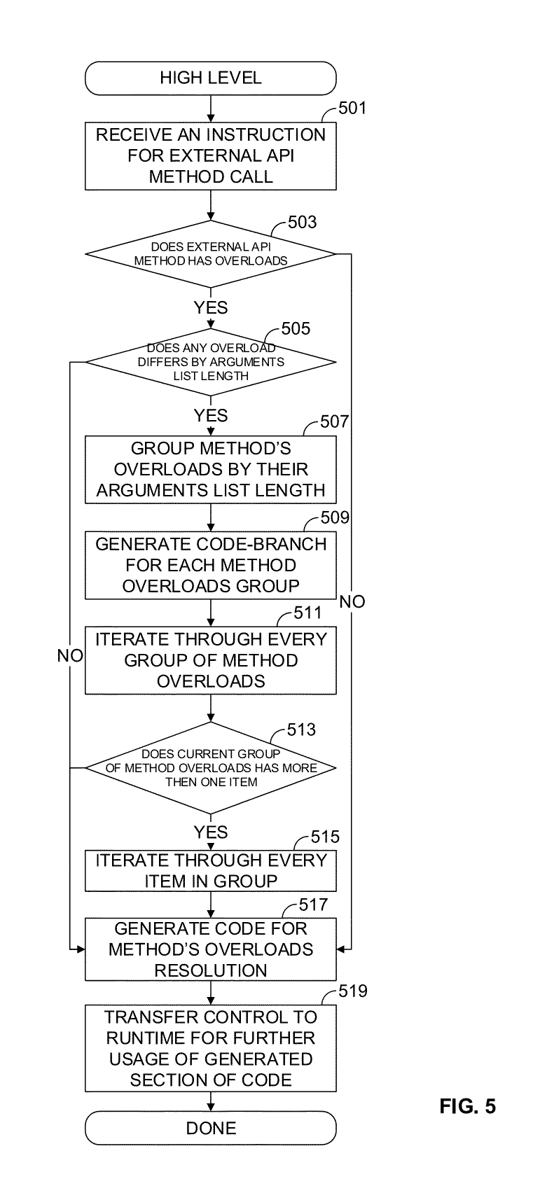

As we can see, function overload resolution algorithm is more intelligent because of most specific argument's type determination. The common algorithm is illustrated in FIG. 5.

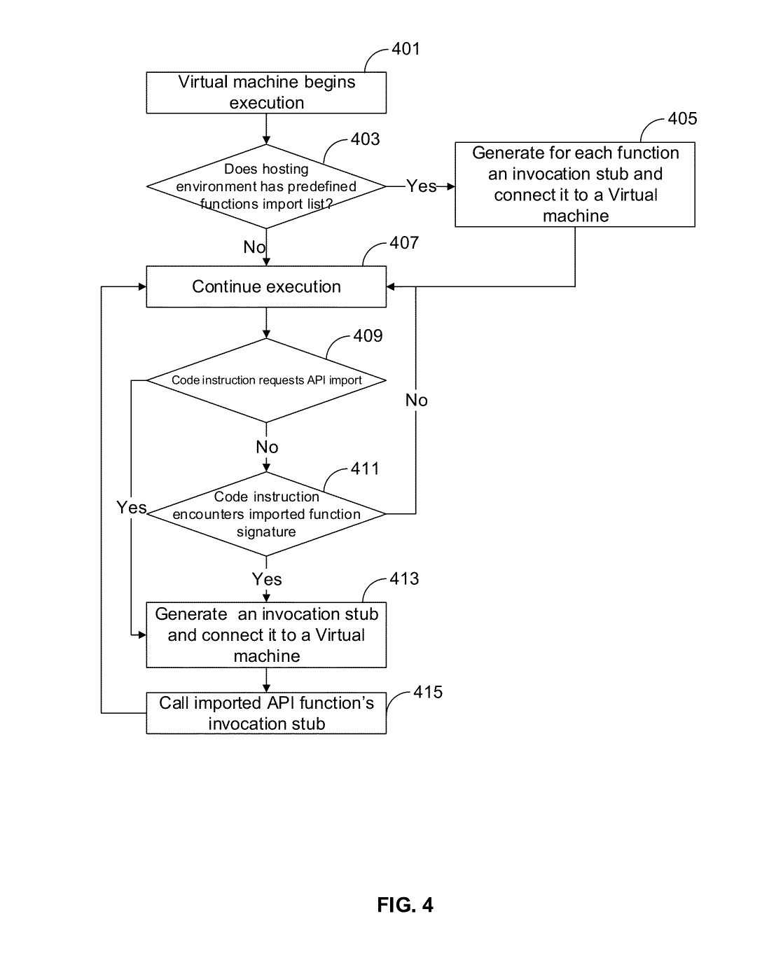

FIG. 4 illustrates a high level flowchart of an embodiment of the invention. The flowchart represents how a function with or without overloads may be determined while efficiently performing runtime checks. The flowchart is shown to illustrate an embodiment of the invention and, as such, one of skill in the art would readily recognize that no specific order of the steps should be implied from the flowchart. Additionally, steps may be added, taken away, and combined without departing from the scope of the invention.

Typically, a system that is compiling invocation stub loops through a process of retrieving and compiling speculative type checks. The flowchart of FIG. 4 shows the process for a single external API function. At a step 401, the system begins execution, while at step 403 receives an instruction for runtime compilation that requires looping through the predefined list of external API methods import. This is done in a case when the instruction may access an API function that has not been loaded. Although API function may be loaded to aid compilation, this may slow down performance since at runtime execution it may not be necessary.

The system compiles the instruction into one or more native instructions at a step 405. Since there is runtime execution information that is needed, placeholder data may be placed in the native instructions. The placeholder data may be random data or data selected to indicate some information during runtime execution. In some embodiments, the placeholder data are optimized code sections with FSM.

At a step 407, the system continues the execution until encounters a new API function import request 409 or imported function instruction 411. The system generates the overload resolution and a callable function at step 413 to transfer control to a section of code at step 415. The mechanism for transferring control may be one of the native instructions that performs this function including a jump, goto, or call. Typically, the native instruction that transfers control is a short instruction that will not overwrite all of the native instructions.

In short, the embodiment, patches incomplete native instructions the first time the native instructions are executed, but subsequent executions of the native instructions will execute in their correct compiled form. This allows embodiments of the invention to achieve fast performance for runtime, for example, API function loading and/or initialization checks.

Referring back FIG. 4, the step 413 is illustrated in FIG. 5.

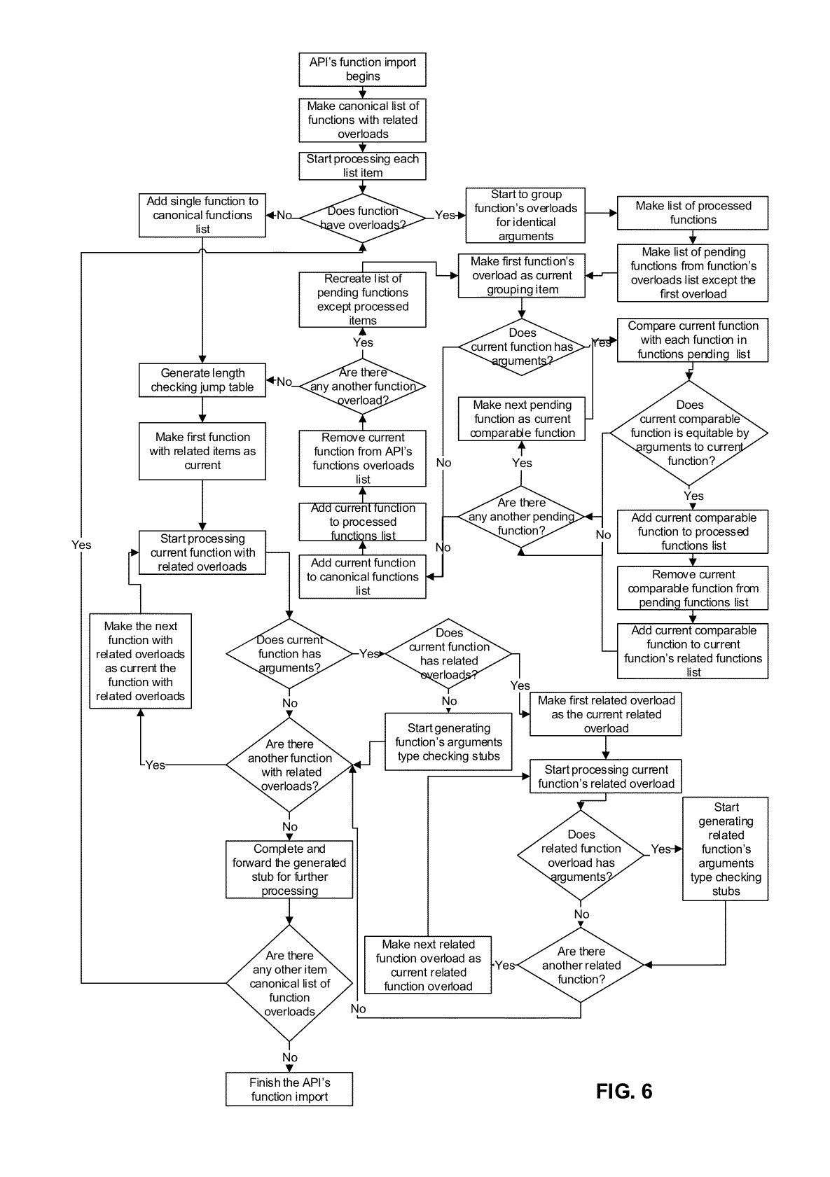

Continuing with discussion of FIG. 5, in one or more embodiments, the common algorithm at step 517 is illustrated in FIG. 6.

JavaScript™ objects (and functions) are dynamically loaded, linked and initialized. Loading is the process of the system finding the binary form of the object (e.g., the source code file) and constructing from the binary form a Prototype object to represent the class. The Prototype object is an object for storing or representing the structures of objects. Linking is the process of taking a binary form of the object and combining it into the runtime state of the system so that it may be executed and accessed. Referring back FIG. 4, in one or more embodiments, linking of an object includes connecting the object's external native fields declared in the object, while linking of a function includes connecting the function's external native body of the function.

Further, in one or more embodiments, the implementation method described herein reduces dependence on other programming languages being implemented for the target instruction set architecture. That is, in one or more embodiments of the invention, the ability to port the just-in-time compiler subsystem or virtual machine subsystem to a particular instruction set architecture does not depend on the presence of a particular programming language—only that the subsystem, function overload resolution compiler, and any necessary extensions be implemented for the target instruction set architecture.

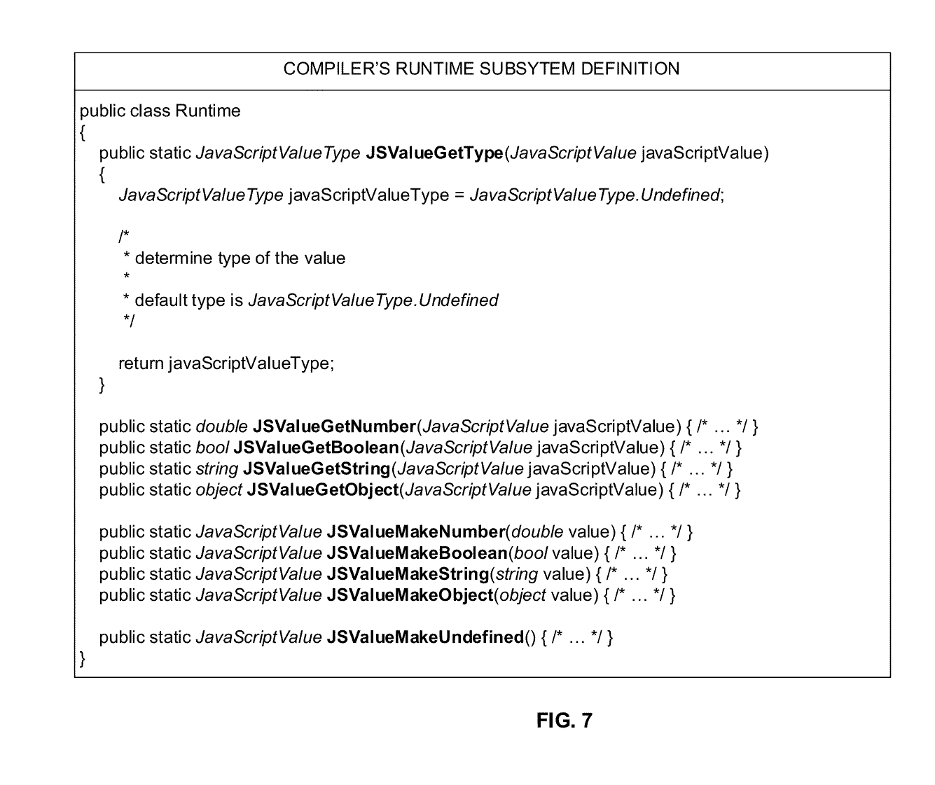

Specifically, in one or more embodiments of the invention, a typical runtime is implemented using a template-based approach. A template is a sequence of functions that implements the logic of a general set of operation. In a template-based approach, the runtime maintains one or more optimized function templates for each operation in the C# language. During code execution, the just-in-time compiler's additional APIs support layer compiles function invocation stubs as they are encountered or predefined within virtual machine, i.e. hosting environment, by emitting copies of the corresponding native templates into memory. A sample definition for a runtime is illustrated in FIG. 7.

Further, in one or more embodiments, the logic of the template-based runtime and just-in-time compiler's APIs importing layer are architecture neutral (i.e., not designed for a specific instruction set architecture), and may be written entirely in a platform independent high-level programming language. Thus, only the APIs of the native runtime themselves depends heavily on a specific programming language hosting environment. In one or more embodiments of the invention, the set of operations, i.e. the part of runtime, are written instead in the same high-level language that is compiled into instructions of the intermediate language. For example, C# language compiles into Common Intermediate Language, then, the existing optimizing compiler is used to automatically produce optimized native code templates, which ones gets connected to dynamic language interpreter or virtual machine. Thus, one or more embodiments of the invention significantly decrease the large amount of tedious and error-prone manual effort typically required to write bindings.

Although the examples and illustrations described herein relate specifically to JavaScript™, it will be understood by those of ordinary skill in the art that these concepts relate generically to any dynamically typed computer programming language by a virtual execution environment with JIT compiler and to providing applications with the capability to use described herein optimization techniques of their choice. As a result, enabling a heterogeneous set of applications to execute together.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method comprising:
receiving an Application Programming Interface (API) function into an execution environment (virtual machine);
receiving a group of functions with overloads as input for the interpreter or just-in-time compiler (JIT);
compiling code section for the received API function with overloads resolution support;
generating the code section branches when demand for the API function import request, wherein compiling the code section itself and corresponding fragments (branches) comprises:
statically compiling the API function overloads arguments type check fragments using template-based approach; and
compiling the built-in function modules into native code at runtime;
wherein the compiling is performed by an just-in-time (JIT) compiler or only subsystem of it in the execution environment (virtual machine),
wherein the native code invokes the built-in function modules via native interface of a JIT or only subsystem of it,
wherein the JIT compiler itself or only subsystem of it generates the native code from variable instructions associated with the API function, the generated code having the ability to invoke the built-in functions via an JIT native interface, and interpreting code section when interpreter is only available option instead of generating native code using jut-in-time compiler (JIT);

2. In a computer system, a method for increasing the execution speed of virtual machine instructions at runtime, the method comprising:
receiving an instruction for runtime compilation that requires runtime execution information;
generating, at runtime, a new method stub that represents or references one or more native instructions that can be executed instead of using generic function for complete enumeration and backtracking for function overload resolution;
receiving an invocation of a method;
wherein if the method is executing in interpreted mode, the interpretation involves maintaining a shared state, i.e. compiled native code, for each importing API's function with overloads during execution, wherein a given state indicates whether a given method is a stub or not;

3. A computer program product for providing extensible applications, while enabling a heterogeneous set of applications to execute together, comprising:
generating a section of native machine instructions that, at runtime, performs function overload resolution with the required runtime execution information, and transfers control to the caller's location or virtual machine itself;
